(19) United States
(12) Patent Application Publication
(10) Pub. No.: US 2017/0328285 A1
(43) Pub. Date: Nov. 16, 2017

(54) SLOTLESS BRUSHLESS MOTOR-DRIVEN THROTTLE VALVE DEVICE, ENGINE, AND VEHICLE

(71) Applicant: Nidec Copal Corporation, Tokyo (JP)

(72) Inventors: Hidekuni YOSHIKAWA, Tokyo (JP); Yasunobu TAKAHASHI, Tokyo (JP); Masaru WADA, Tokyo (JP)

(73) Assignee: Nidec Copal Corporation, Tokyo (JP)

(21) Appl. No.: 15/510,055

(22) PCT Filed: Sep. 16, 2015
(86) PCT No.: PCT/JP2015/076249

§ 371 Date: Mar. 9, 2017

(30) Foreign Application Priority Data
Sep. 19, 2014 (JP) 2014-191786

(51) Int. Cl. F02D 9/10; F02D 11/10; H02K 26/00; F02D 9/02

(52) U.S. Cl. CPC F02D 9/1065; F02D 9/105; F02D 11/105; H02K 26/00; F02D 9/104; F02D 2009/0235; F02D 2009/0205

(57) ABSTRACT

The present invention provides a compact throttle valve device with good valve responsiveness and small unnecessary vibrations, an engine, and a vehicle. A slotless brushless motor-driven throttle valve device has a throttle body provided with a tubular portion in which an intake air passage is formed, a throttle valve disposed in the tubular portion, and a slotless brushless motor serving as a drive motor for performing opening/closing drive for the throttle valve. The throttle body housing has a hole portion into which a fixing member for fixing the throttle body to a member to be attached is inserted. The hole portion is formed in the vicinity of the outer circumferential portion of the tubular portion. The compact, narrow slotless brushless motor is disposed near the hole portion formed in the throttle body, and the throttle valve device is very compact.

### CROSS-REFERENCE TO RELATED APPLICATIONS

This is a U.S. national phase application under 35 U.S.C. §371 of International Patent Application No. PCT/JP2015/076249, filed Sep. 16, 2015, and claims benefit of priority to Japanese Patent Application No. 2014-191786, filed Sep. 19, 2014. The entire contents of these applications are hereby incorporated by reference.

### FIELD OF TECHNOLOGY

The present invention relates to a slotless brushless motor-driven throttle valve device, engine, and vehicle.

### BACKGROUND

There are known motor actuators and motor-driven throttle valve devices for internal combustion engines that use such motor actuators (see, for example, Japanese Unexamined Patent Application Publication No. 2007-236037). The throttle valve device for a typical internal combustion engine has a DC cored motor, where the throttle valve is driven by the DC cored motor.

### SUMMARY

However, because the DC cored motor is relatively big, the throttle valve device that incorporates the DC cored motor is relatively big. On the other hand, it is desirable to miniaturize the throttle valve devices for internal combustion engines for automobiles, motorcycles (motor scooters), and the like.

Moreover, because in a throttle valve device that as a DC cored motors the moment of inertia of the rotor of the DC cored motor is relatively large, sometimes the valve responsiveness is not good. More specifically, when a driving signal for opening or closing a valve is inputted into the DC cored motor, arriving at the prescribed valve angle may take some time, or the angle may overshoot, or chattering may occur when opening or closing the valve, which may reduce fuel consumption.

Moreover, a typical throttle valve device has a structure wherein the intake manifold or engine main unit portion (the main unit portion of the internal combustion engine), or the like, is secured through attaching bolts (securing members) to an attaching member, and when the engine operates, the engine main unit portion and the throttle valve device vibrate essentially synchronously.

However, when the DC cored motor is placed at a position that is far from the position of attachment of the securing member, the DC cored motor will have a relatively large moment of inertia (in respect to the position of attachment), and a vibration that is of a greater amplitude than the vibration of the engine main unit portion will act thereon, reducing the service life of the DC cored motor. A throttle valve device wherein the extraneous vibration relative to such a DC cored motor is reduced is desirable.

In the present invention, the handling of such problems is an example of the problem to be solved. That is, objects are to provide a compact throttle valve device, to provide a throttle valve device with good valve responsiveness, to provide a throttle valve device that reduces extraneous vibration, to provide an engine equipped with such a throttle valve device, and to provide a vehicle equipped with such an engine.

In order to achieve such an object, the slotless brushless motor-driven throttle valve device of the present invention is equipped with at least the following structures:

A slotless brushless motor-driven throttle valve device comprising:
a throttle body equipped with a tubular portion having an air intake passage formed therein;
a throttle valve that is disposed within the tubular portion; and
a slotless brushless motor, as a driving motor for driving the throttle valve open and closed, wherein:
the throttle body has a hole portion into which is inserted a securing member for securing the throttle body to an attaching member;
the hole portion is provided in the vicinity of the outer peripheral portion of the tubular portion; and
the slotless brushless motor is provided in proximity to the hole portion that is provided in the throttle body.

The engine according to the present invention is equipped with the slotless brushless motor-driven throttle valve device according to the present invention, set forth above.

Moreover, the vehicle according to the present invention equipped the engine according to the present invention, set forth above.

The present invention can provide a compact throttle valve device. Moreover, the present invention can provide a throttle valve device with good valve responsiveness. Moreover, the present invention can provide an engine that is equipped with this throttle valve device. Furthermore, the present invention can provide a vehicle that is equipped with such an engine.

### BRIEF DESCRIPTIONS OF THE DRAWINGS

FIG. 1 is a perspective diagram illustrating an example of a throttle valve device according to an embodiment according to the present invention.

FIG. 2 is a front view illustrating an example of a throttle valve device according to an embodiment according to the present invention.

FIG. 3 is a cross-sectional view illustrating an example of a throttle valve device according to an embodiment according to the present invention.

FIG. 4 is a cross-sectional view illustrating an example of a slotless brushless motor of a throttle valve device according to an embodiment according to the present invention.

FIG. 5 is an exploded perspective diagram of a slotless brushless motor of a throttle valve device according to an embodiment according to the present invention.

FIG. 6 is a conceptual diagram illustrating an example of an internal combustion engine that is equipped with a throttle valve device according to an embodiment according to the present invention.

### DETAILED DESCRIPTION

The throttle valve device according to an embodiment according to the present invention is an electronically controlled throttle valve device that is equipped with a slotless brushless motor. Moreover, an engine that is equipped with this throttle valve device can be provided. Moreover, a vehicle that is equipped with this engine can be provided.

Specifically, in the slotless brushless motor, a coil that is formed into a cylinder is disposed within a stator. A magnet that is secured to a rotor is disposed within the coil. The structure is such that the rotor and the magnet are rotated through application of electric power to the coil. A small gap (an air space) is provided between the magnet and the coil, and the slotless brushless motor is compact. That is, the use of a compact slotless brushless motor enables the provision of a compact throttle valve device.

Embodiments according to the present invention will be explained below, in reference to the drawings.

While the embodiments of the present invention include the detail in the drawings, there is no limitation thereto. Note that in the explanations of the various drawings below, those parts that are the same as parts already explained will be assigned identical reference symbols, and redundant explanations will be partially omitted.

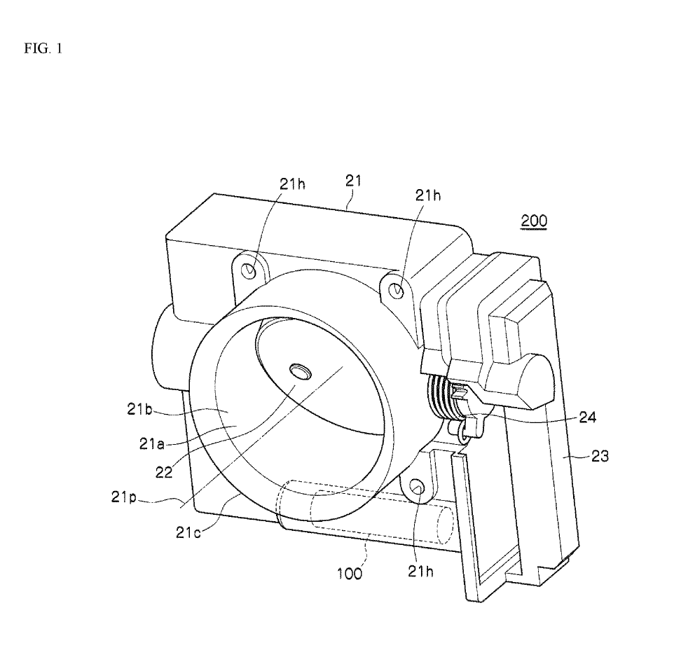

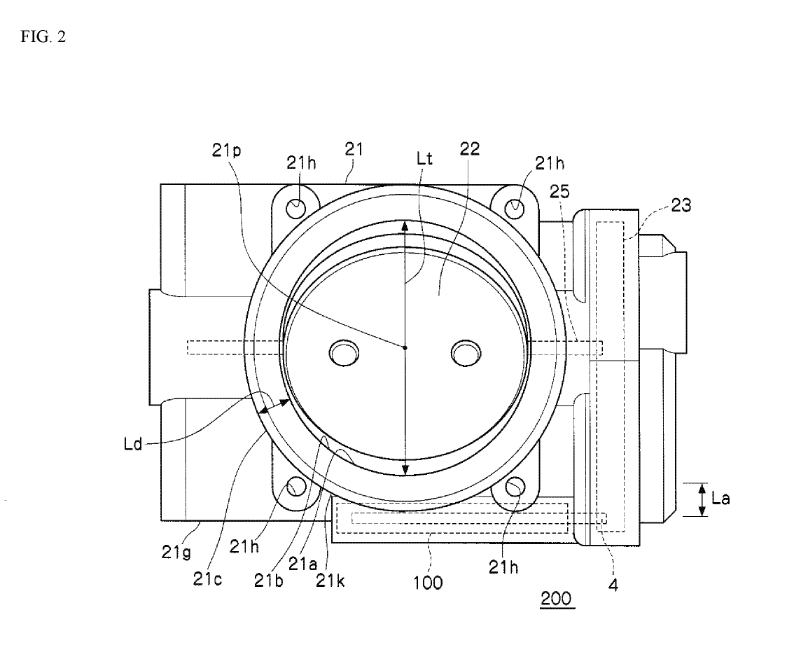

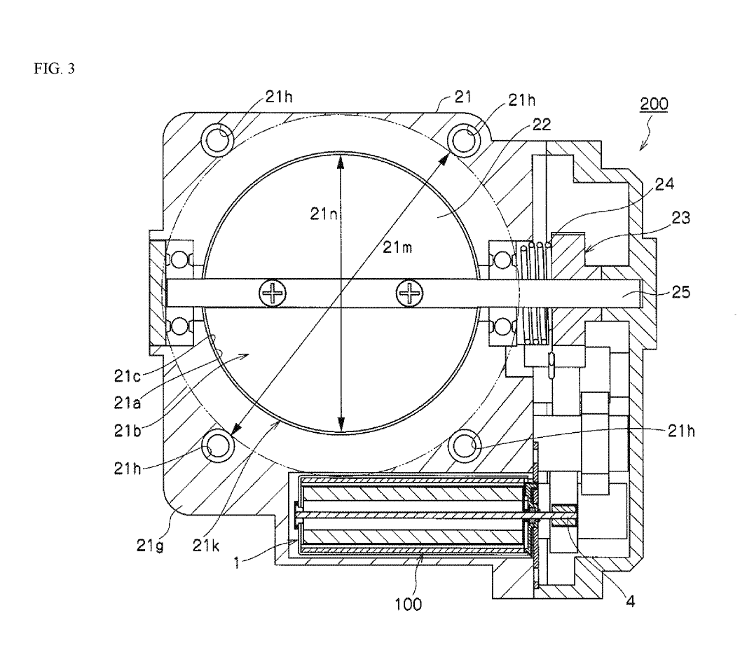

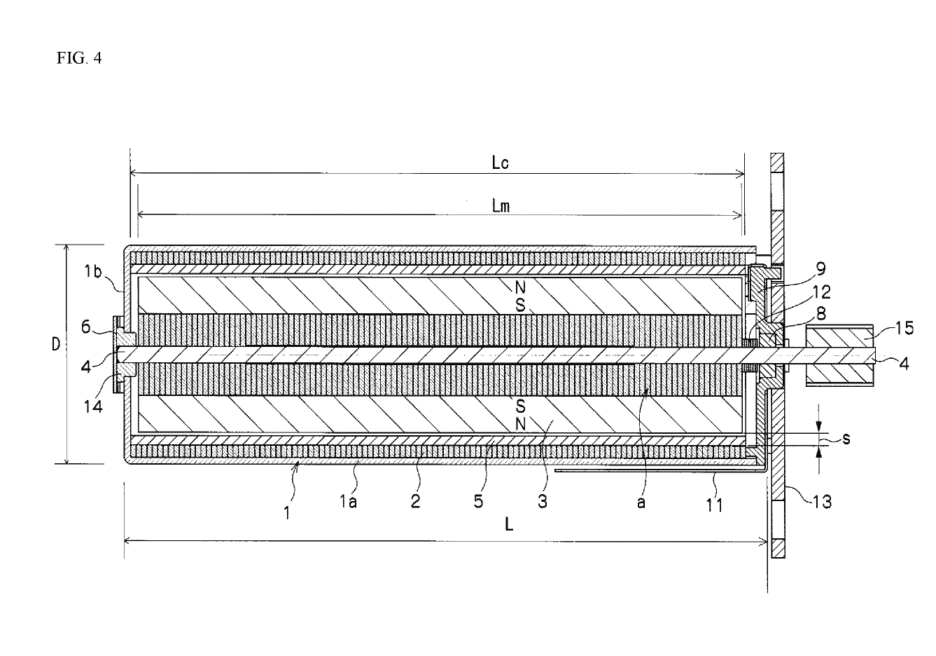

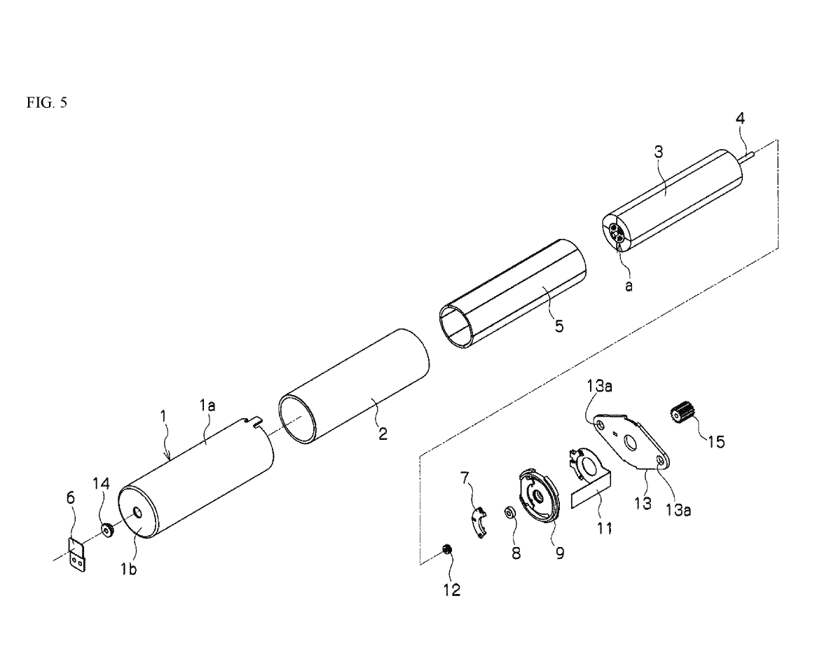

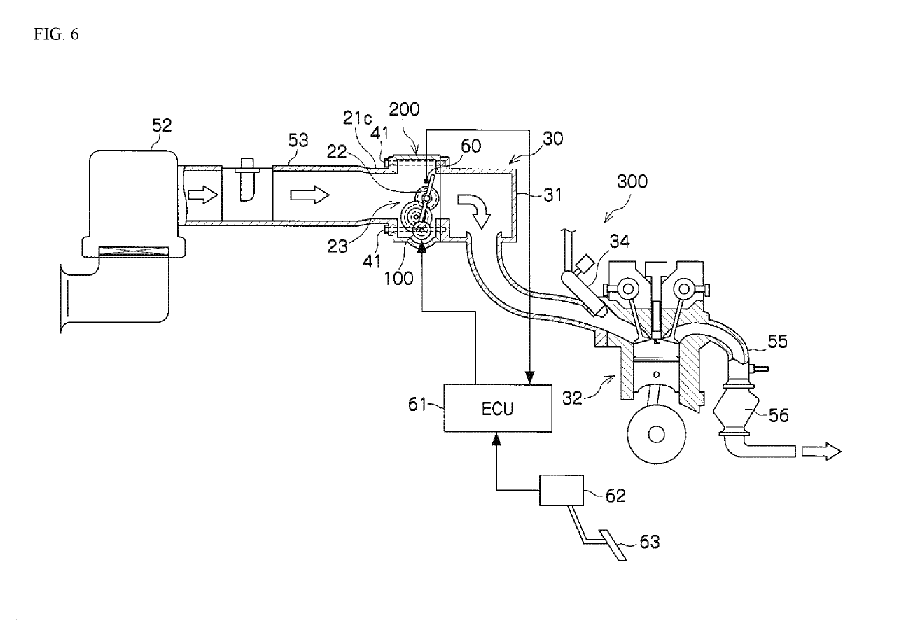

FIG. 1 is a perspective diagram illustrating an example of a slotless brushless motor-driven throttle valve device 200 according to an embodiment according to the present invention. FIG. 2 is a front view illustrating an example of the throttle valve device 200. FIG. 3 is a cross-sectional view illustrating an example of the throttle valve device 200. FIG. 4 is a cross-sectional view illustrating an example of a slotless brushless motor for the throttle valve device 200. FIG. 5 is an exploded perspective diagram of the slotless brushless motor for the throttle valve device 200. FIG. 6 is a conceptual diagram illustrating an example of an internal combustion engine that is equipped with the throttle valve device 200.

An engine 300 will be explained as an internal combustion engine that incorporates a throttle valve device 200 that is equipped with a slotless brushless motor 100 according to an embodiment according to the present invention (referencing FIG. 6). In the below, the “slotless brushless motor” will be termed simply a “motor.”

In the present embodiment, the engine 300 as an engine main unit portion 32, such as a cylinder block, where a fuel injector 34 (a fuel injecting device), an air intake valve, an exhaust valve, a camshaft, a spark plug, a piston, a crankshaft, and the like, are provided in the engine main unit portion 32, where an intake manifold 31 is provided on the air intake side, and a throttle valve device 200 is secured, through a securing member 41 such as an attaching bolt, to the intake manifold 31. An air intake tube member 53, an air filter 52, and the like, are provided in a tubular portion 21c of the throttle valve device 200. An exhaust manifold 55, the catalyst 56, and the like, are provided on the exhaust side of the engine main unit portion 32.

A position sensor 60, for detecting the angle of opening of the throttle valve 22, is provided on the throttle valve device 200, where a signal from the position sensor 60 is outputted to an engine controlling unit 61. An accelerator sensor 62 is connected to the engine controlling unit 61. The accelerator sensor 62 detects the amount of depression of an accelerator pedal 63, to output a detection signal to the engine controlling unit 61.

The engine controlling unit 61 (ECU) carries out comprehensive control of the engine 300, as an internal combustion engine. Specifically, the engine controlling unit 61 drives the motor 100 based on a signal, outputted from the accelerator sensor 62, that indicates the amount of depression of the accelerator pedal 63, a signal, outputted from the position sensor 60, that indicates the angle of opening of the throttle valve 22, and the like, to control the angle of opening of the throttle valve 22, the timing of ignition by the spark plug, the amount and timing of fuel injection by the fuel injector 34, and the like.

The slotless brushless motor-driven throttle valve device 200 according to the embodiment according to the present invention comprises: a throttle body 21 (housing) that is equipped with a tubular portion 21c with a valve hole 21a is formed as an air intake passage 21b therein; a throttle valve 22 that is disposed within the tubular portion 21c and that rotates so as to open and close the valve hole 21a; a valve rod 25 that supports the throttle valve 22 so as to enable rotation; a slotless brushless motor 100, as a driving motor for driving the throttle valve 22 open and closed, disposed on the outside of the throttle valve 22; a transmission mechanism 23 (a speed reducing mechanism) that is provided with a plurality of gears, or the like, for transmitting, to the valve rod 25 (the throttle rod), the driving force of the motor 100; and the like. Moreover, the throttle valve 22 comprises a return spring 24 for maintaining the minimum amount of opening of the throttle valve 22 so as to be essentially constant (referencing FIG. 1 through FIG. 3).

As described below, the motor 100 comprises: a long cylindrical housing 1 (a case); a magnet 3; a rotary shaft 4 that is supported on the housing 1 so as to be able to rotate; a cylindrical coil 5; and the like, wherein: the structure is one wherein the throttle valve 22 can be opened and closed by the rotational force of the rotary shaft 4.

A motor 100 is provided on the outside of the valve hole 21a, with the axial direction of the rotary shaft 4 essentially parallel to the axial direction of the valve rod 25 (the throttle rod). The transmission mechanism 23 (the speed reducing mechanism) is equipped at a side portion on the outside of the valve hole 21a, so as to be essentially perpendicular to the axial direction of the valve rod 25 and of the motor 100.

In the present embodiment, the motor 100 is compact, with a long-thin shape, and the throttle valve device 200 that is equipped with the motor 100 is compact. The respective axial direction lengths Lc and Lm of the coil 5 and the magnet 3 of the motor 100 are less than the total length L of the motor 100, and greater than the diameter D (referencing FIG. 5) of the housing 1 of the motor 100 (the case). In the present embodiment, the diameter D of the motor 100 is about 20 mm, where the total length L is about 60 mm, and the inner diameter (the inner peripheral diameter) L2 of the tubular portion 21c is about 80 mm, where the maximum outer periphery is about 90 mm.

Moreover, the housing 1 (the case) of the motor 100, when viewed in the axial direction of the tubular portion 21c that forms the air intake passage 21b is disposed so that at least one part thereof lies toward the inside from the maximum outer periphery 21m of the tubular portion 21c, and further toward the outside from the outer periphery 21n of the tubular portion 21c (referencing FIG. 2 and FIG. 3). For example, the diameter D of the housing 1 (the case) of the motor 100 (referencing FIG. 4) may be structured so as to have a length that is essentially the same as the thickness Ld of the tubular portion 21c in the radial direction.

Because the throttle valve device 200 is structured so as to open and close the throttle valve 22 through a compact slotless brushless motor 100 that is long in the axial direction, the length of extension of the slotless brushless motor 100 can be made relatively small, and an output torque of the slotless brushless motor 100 can be obtained adequately, with a surplus, relative to the rotational load of the throttle valve 22. This makes it possible to provide a throttle valve device 200 that is compact and that has superior responsiveness.

Moreover, in the throttle valve device 200, the overall shape is a rectangular block that is almost square, enabling easy installation into a relatively narrow space, such as into an engine chamber.

Furthermore, in the present embodiment, in the throttle valve device 200, the housing 1 (the case) of the slotless brushless motor 100, when viewed from the direction of the axis (21p) of the tubular portion 21c that forms the air intake passage 21b, is disposed so that at least one part thereof overlays a connecting portion 21k between the throttle body main unit portion 21g and the tubular portion 21c. In this case, the length of protrusion from the slotless brushless motor 100 can be made extremely small.

Moreover, in the throttle valve device 200, the throttle body 21 (the housing) has a hole portion 21h into which is inserted a securing member 41 (an attaching bolt) for securing the throttle body 21 to an attaching member 30 (the engine main unit portion 32, the intake manifold 31, or the like). This hole portion 21h is provided in the vicinity of the outer peripheral portion of the tubular portion 21c. The slotless brushless motor 100 is provided in proximity to the hole portion 21h that is provided in the throttle body 21. Specifically, the slotless brushless motor 100 is provided in proximity to the hole portion 21h that is provided between the tubular portion 21c and the slotless brushless motor 100. Because the structure in the present embodiment is as described above, the distance La between the slotless brushless motor 100 and the hole portion 21h is short.

When the engine is operating, the throttle valve device 200 and the attaching member 30, such as the engine main unit portion 32, the intake manifold 31, or the like, vibrate essentially synchronously. Specifically, because the slotless brushless motor 100 is disposed at a position that is only an extremely short distance away from the attaching position (the hole portion 21h) for the securing member 41 (the attaching bolt), it has a relatively small moment of inertia (in respect to the position of the attachment), making it possible to reduce extremely the extraneous vibration that differs from the vibration of the attaching member 30 (the engine main unit portion 32, the intake manifold 31, or the like).

The individual structural elements of the slotless brushless motor 100 will be explained in detail next, in reference to FIG. 4, FIG. 5, and the like.

Note that in the explanations below, “front” or “forward” refer to the output side, in the axial direction, of the rotary shaft 4 (the right side in FIG. 4), and “back” or “rearward” refers to the side that is opposite from the “front” or “forward” (the left side in FIG. 4).

The slotless brushless motor 100, as illustrated in FIG. 4 in FIG. 5, comprises: a long cylindrical housing 1 (a case); a long cylindrical stator 2 (a yoke) that is connected, so as to be able to rotate relative to the housing 1, to the center side thereof; a coil 5 that is formed in a cylindrical shape within the stator 2; a cylindrical magnet 3 that is secured to the rotor a on the inside of the coil 5; a rotary shaft 4 that passes through the interior of the rotor a and that is supported, so as to be able to rotate relative to the housing 1, through supporting members 14 and 8; a constraining member 6 for constraining movement of the rotary shaft 4 toward the back side; a member 9 for covering the front opening portion of the housing 1; a metal member 7 that is provided on the backside of this member 9; a terminal 11; a washer 12, for constraining movement of the rotary shaft 4 toward the front side; and a bearing flange 13; structured so as to be able to open and close the throttle valve through the rotational force of the rotary shaft 4.

The housing 1 comprises a long cylindrical cylinder portion 1a that is integrated with a bottom 1b at the position of the back end portion of the cylinder portion 1a, to form an essentially closed-bottom cylinder from a magnetic metal material.

Moreover, the stator 2 (the yoke) is a long cylindrical member formed from a magnetic metal material, with the coil 5 provided therewithin, and the housing 1 is secured through securing means, such as adhesive bonding, press fitting, or the like, to the outer peripheral surface thereof. This enables a reduction in the space through which the magnetic flux flows between the stator 2 and the magnet 3.

The magnet 3 is formed in a long cylindrical shape, having magnetic poles in mutually opposing radial directions, from an arbitrary permanent magnet material, such as, for example, and alnico magnet or a rare earth magnet.

This magnet 3 is formed so that the back end side (the left end side in FIG. 4) is shorter than the stator 2. That is, the back end side of the stator 2 protrudes rearward further than the back end portion of the magnet 3.

This magnet 3 is secured to the outer peripheral portion of the cylindrical rotor a, and a rotary shaft 4 is provided in the interior of the rotor a.

A slight gap s (an air space) is provided between the magnet 3 and the coil 5, structured so that the rotor a and the magnet 3 are rotated through application of electric power to the coil 5.

The rotary shaft 4, in a state wherein a gap is secured between the rotary shaft 4 and the inner peripheral surface of the stator 2, is inserted coaxially within the stator 2, and the front end side protrudes further forward than a bearing flange 13 and the back end side protrudes further rearward than the bottom 1b.

The front end side of the rotary shaft 4 is supported, so as to enable rotation, by a supporting member 8 on the center side of the bearing flange 13, described below, of the rotary shaft 1 and the back end side of the rotary shaft 4 is supported, through a supporting member 14, on the back end side of the stator 2, so as to be able to rotate. The supporting member 14, as a bearing member, may be, for example, a slide bearing, but a rolling bearing, such as a ball bearing, or the like, may be used instead. An output gear 15 is secured to the side of the rotary shaft 4 further forward from the bearing flange 13.

The cylindrical coil 5 is a coil that is structured into a long cylindrical shape, and secured by a synthetic resin, and is positioned in a space between the inner peripheral surface of the housing 1 and the outer peripheral surface of the magnet 3, and secured to the inner peripheral surface of the stator 2.

Moreover, a lead wire, not shown, leads out from the front end side of the cylindrical coil 5, where this lead wire is connected electrically to the terminal 11.

The bearing flange 13 supports the rotary shaft 4 so as to be able to rotate, and is a flange-shaped member that has attaching holes 13a on both end sides in the radial direction. The attaching holes 13a are used for securing the motor 100 to the throttle valve controlling unit.

Given this, the motor 100, structured as described above, rotates the rotor a and the magnet 3 smoothly, through application of electric power to the terminal 11.

The gap between the magnet and the inner peripheral surface of the cylindrical coil 5, and the like, can be set so as to be small, to increase effectively the output power.

For example, given the example illustrated in FIG. 4, the distance in the radial direction between the inner peripheral surface of the stator 2 and the outer peripheral surface of the magnet 3 is about 1 mm, the diameter D of the housing 1 is about 20 mm, and the total length L of the housing 1 is about 60 mm.

That is, the housing 1 of the motor 100 is of a long-thin shape, with the total length L thereof being about three or four times the diameter D of the housing 1. Such a motor 100 enables high-precision control of the throttle valve device 200 through the diameter Lt of the tubular portion 21c being about five times the diameter D of the housing 1.

Note that while the embodiment set forth above showed an example wherein the motor 100 illustrated in FIG. 4 and FIG. 5 was incorporated into the throttle valve device 200, there is no limitation to the detailed portions of the motor 100 having these shapes. The motor 100 that is built into the throttle valve device 200 may instead be small, but long in the axial direction.

Moreover, as explained above, the slotless brushless motor-driven throttle valve device 200 according to an embodiment according to the present invention comprises: a throttle body 21 (a housing) that is equipped with a tubular portion 21c wherein a valve hole 21a is formed, as an air intake passage 21b in the interior thereof; a throttle valve 22 that is disposed within the tubular portion 21c; and a slotless brushless motor 100, as a driving motor for driving the throttle valve 22 open and closed.

The throttle body 21 (the housing) has a hole portion 21h into which is inserted a securing member 41 (an attaching bolt) for securing the throttle body 21 to an attaching member 30 (the engine main unit portion 32, the intake manifold 31, or the like). This hole portion 21h is provided in the vicinity of the outer peripheral portion of the tubular portion 21c. The slotless brushless motor 100 is provided in proximity to the hole portion 21h that is provided in the throttle body 21.

As described above, the throttle valve device 200 has a structure wherein a long-thin compact slotless brushless motor 100 is disposed in the vicinity of a hole portion 21h that is provided in the throttle body 21, and thus is extremely compact.

Moreover, when the engine is operating, the throttle valve device 200 and the attaching member 30, such as the engine main unit portion 32, the intake manifold 31, or the like, vibrate essentially synchronously. Specifically, because the slotless brushless motor 100 is disposed at a position that is only an extremely short distance away from the attaching position (the hole portion 21h) for the securing member 41 (the attaching bolt), it has a relatively small moment of inertia (in respect to the position of the attachment), making it possible to provide a compact throttle valve device 200 able to reduce extremely the extraneous vibration that differs from the vibration of the attaching member 30 (the engine main unit portion 32, the intake manifold 31, or the like).

Moreover, the housing 1 (the case) of the slotless brushless motor 100, when viewed in the axial direction of the tubular portion 21c that forms the air intake passage 21b is disposed so that at least one part thereof lies toward the inside from the maximum outer periphery 21m of the tubular portion 21c, and further toward the outside from the outer periphery 21n of the tubular portion 21c (referencing FIG. 2 and FIG. 3).

Specifically, in the throttle valve device 200, the housing 1 (the case) of the slotless brushless motor 100, when viewed in the axial direction of the tubular portion 21c that forms the air intake passage 21b, is disposed so that at least one part thereof overlays a connecting portion 21k between the throttle body main unit portion 21g and the tubular portion 21c.

That is, the structure wherein the compact slotless brushless motor 100 is disposed extremely near to the tubular portion 21c makes it possible to provide a compact throttle valve device 200.

Moreover, the throttle valve device 200 being equipped with the compact slotless brushless motor 100 enables the provision of a compact throttle valve device 200 wherein the valve responsiveness is good.

An engine equipped with the slotless brushless motor-driven throttle valve device according to the embodiment according to the present invention can be provided.

Moreover, a vehicle that is equipped with an engine according to an embodiment according to the present invention can be provided. The vehicle may be an automobile, a motorcycle, a hybrid vehicle, or the like.

While the embodiments of the present invention were described in detail referencing the drawings, the specific structures are not limited to those in these embodiments, but rather design changes, and the like, within a range that does not deviate from the spirit or intent of the present invention are included within the present invention.

Moreover, insofar as there are no particular contradictions or problems in purposes, structures, or the like, the details that are described for the embodiments illustrated in the various drawings described above may be combined.

Moreover, the details described in each of the drawings can be respectively independent embodiments, and the embodiments of the present invention are not limited to a single embodiment combining each of the drawings.

1. A slotless brushless motor-driven throttle valve device comprising:
a throttle body equipped with a tubular portion having an air intake passage formed therein;
a throttle valve that is disposed within the tubular portion; and
a slotless brushless motor driving the throttle valve open and closed,
wherein the throttle body has a hole portion into which is inserted a securing member securing the throttle body to an attaching member;
wherein the hole portion is provided in the vicinity of the outer peripheral portion of the tubular portion; and
wherein the slotless brushless motor is provided in proximity to the hole portion that is provided in the throttle body.

2. An engine equipped with a slotless brushless motor-driven throttle valve device set forth in claim 1.

3. A vehicle equipped with an engine set forth in claim 2.
